(19) United States
(12) Patent Application Publication
(10) Pub. No.: US 2011/0038003 A1
(43) Pub. Date: Feb. 17, 2011

(54) PRINTING APPARATUS FOR PRINTING RECEIVED PRINT DATA

(75) Inventors: Mahina Nakamura, Tokyo (JP); Maki Sato, Kanagawa-ken (JP); Tsunehiro Motegi, Tokyo (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/852,837

(22) Filed: Aug. 9, 2010

Related U.S. Application Data
(60) Provisional application No. 61/232,863, filed on Aug. 11, 2009.

(51) Int. Cl. G06F 3/12

(52) U.S. Cl. 358/1.15

(57) ABSTRACT

A printing apparatus includes a communication unit configured to receive print data including first information regarding printing setting information set in advance and second information regarding inhibition information with printing settings inhibited from being changed among the first information, an operation unit configured to be operated so as to change the printing setting information of print data, and a controller configured to inhibit the printing setting information corresponding to the second information from being changed through the operation unit.

### CROSS-REFERENCE TO RELATED APPLICATION(S)

This application is also based upon and claims the benefit of priority from U.S. provisional application 61/232863, filed on Aug. 11, 2009; the entire contents of which are incorporated herein by reference.

### FIELD

An embodiment described in this specification relates to a printing apparatus.

### BACKGROUND

As a method which distributes printed matter to a person at a distance, there are suggested a first method which sends printed matter by mail, and a second method in which print data is sent to the other party and the other party performs printing on the basis of print data.

However, according to the first method, it takes a lot of time to perform printing and to send printed matter, and mailing cost is incurred. According to the second method, the other party may freely change printing setting information, thus printed matter which is not intended by a creator may be printed.

### BRIEF DESCRIPTION OF THE DRAWINGS

FIG. 1 is a sectional view of an MFP.

FIG. 2 is a conceptual diagram of a communication system of the MFP.

FIG. 3 is a schematic view of a display screen on which printing setting information and inhibition information are set.

FIG. 4 is a flowchart showing a printing method of a first embodiment.

FIG. 5 is a schematic view schematically showing reception information displayed on an operation display unit 805.

FIG. 6 is a flowchart showing the printing method of the first embodiment.

FIG. 7 is a data table showing the printing functions of other MFPs which are communicable with the MFP 1.

FIG. 8 is a flowchart showing a printing method of a second embodiment.

FIG. 9 is a data table showing the analogous relationship of printing functions between different models of MFPs.

### DETAILED DESCRIPTION

In general, an embodiment provides a printing apparatus. The printing apparatus includes a communication unit configured to receive print data including first information regarding printing setting information set in advance and second information regarding inhibition information with printing settings inhibited from being changed among the first information, an operation unit configured to be operated so as to change the printing setting information of print data, and a controller configured to inhibit the printing setting information corresponding to the second information from being changed through the operation unit.

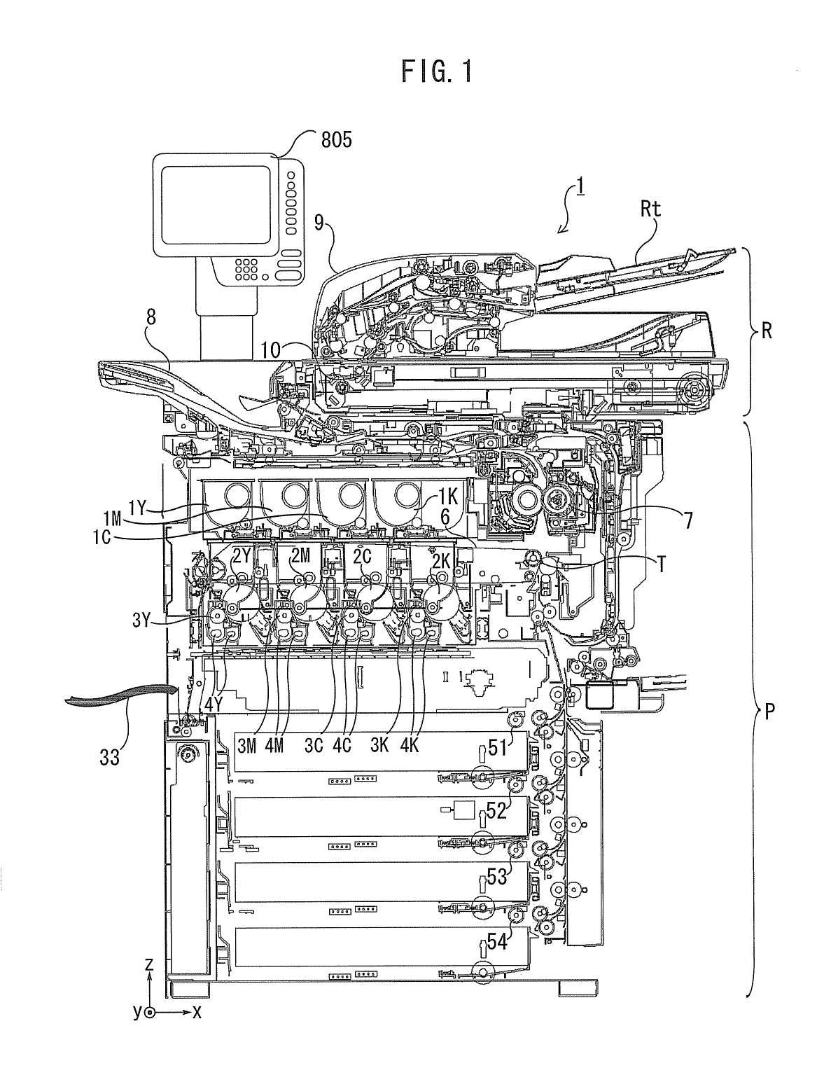

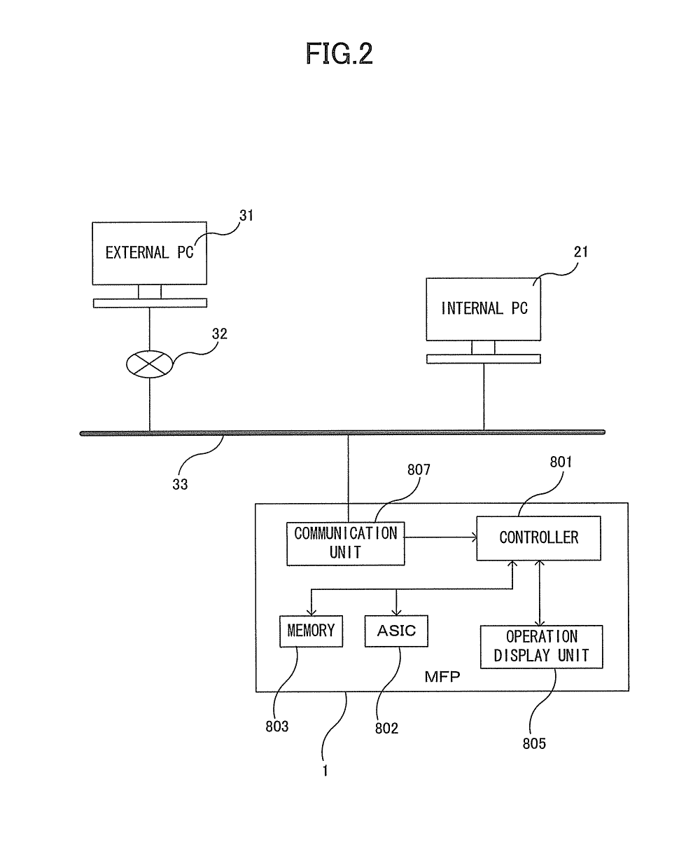

FIG. 1 is a sectional view of an MFP. The X axis, the Y axis, and the Z axis represent three different orthogonal axes. FIG. 2 is a conceptual diagram of a network system of the MFP.

Referring to FIG. 1, an MFP 1 includes an image reading unit R and an image forming unit P. The image reading unit R has a function for reading images of a sheet-type original document and a book-type original document through scanning.

The image forming unit P has a function for forming developer images on the sheets on the basis of the images read from the original document by the image reading unit R, print data transmitted from an external apparatus to an image processing apparatus, or the like.

The image reading unit R includes an auto document feeder (ADF) 9 which automatically feeds an original document to a predetermined image reading position, and reads the images of an original document automatically fed by the automatic document feeder 9 and placed on an original document tray (a predetermined document placing table) Rt, or an original document placed on a platen (not shown) by a scanning optical system 10.

The image forming unit P includes toner cartridges 1Y to 1K, pickup rollers 51 to 54, photoconductors 2Y to 2K, developing rollers 3Y to 3K, mixers 4Y to 4K, an intermediate transfer belt 6, a fixing device 7, and a discharge tray 8.

Referring to FIG. 2, the MFP 1 of this embodiment includes a controller 801, an ASIC circuit 802, a memory 803, an operation display unit 805, and a communication unit 807. The controller 801 plays a role in performing various kinds of processing in the image processing apparatus, and also plays a role in realizing various functions by executing a program stored in the memory 803. The memory 803 is, for example, a RAM (Random Access Memory), a ROM (Read Only Memory), a DRAM (Dynamic Random Access Memory), an SRAM (Static Random Access Memory), or a VRAM (Video RAM), and plays a role in storing various kinds of information or programs for use in the image processing apparatus.

The operation display unit 805 displays a change screen on which printing settings are changed, or the like, and is operated so as to change printing settings. The operation display unit 805 may be of a touch panel type.

A LAN cable 33 is connected to the communication unit 807. The communication unit 807 performs communication with a terminal outside the MFP 1 through the LAN cable 33.

The outline of copying will be hereinafter described as an example of processing in the image processing apparatus of this embodiment.

First, sheets picked up from the cassette by the pickup rollers 51 to 54 are fed into a sheet carrying path. The sheets fed into the sheet carrying path are carried in a predetermined transport direction by a plurality of pairs of rollers.

Then, the images of a plurality of sheets of the sheet-type original document automatically fed consecutively by the automatic document feeder 9 are read at a predetermined image reading position by the scanning optical system 10.

Next, electrostatic latent images are formed on the photoconductive surfaces of the photoconductors 2Y, 2M, 2C, and 2K, which transfer the developer images of yellow (Y), magenta (M), cyan (C), and black (K) onto the sheets, on the basis of print data of the images read from the original document by the image reading unit R.

Subsequently, the developers which are stirred by the mixers 4Y to 4K in the developing device are supplied to the photoconductors 2Y to 2K, on which the electrostatic latent images are formed in the above-described manner, by the developing rollers 3Y to 3K. Thus, the electrostatic latent images formed on the photoconductive surfaces of the photoconductors are visualized.

The developer images formed on the photoconductors in the above-described manner are transferred onto the belt surface of the intermediate transfer belt 6 (so-called primary transfer). The developer images which are carried in accordance with the rotation of the intermediate transfer belt are transferred onto the sheets being fed at a predetermined secondary transfer position T.

The developer images transferred onto the sheets are heated and fixed to the sheets by the fixing device 7.

The sheets to which the developer images are heated and fixed are carried in the carrying path by a plurality of pairs of carrying rollers, and are sequentially discharged onto the discharge tray 8.

Referring to FIG. 2, this network includes an internal PC 21, the MFP 1, and an external PC 31. The internal PC 21 is connected to the communication unit 807 of the MFP through the LAN cable 33. The external PC 31 is connected to the communication unit 807 of the MFP 1 and the internal PC 21 through Internet 32 and the LAN cable 33. The external PC 31 may transmit print data to the internal PC 21 through Internet 32 and the LAN cable 33, for example, by electronic mail. The internal PC 21 may receive print data created by the external PC 31 and transmit the print data to the communication unit 807 of the MFP 1. The external PC 31 may directly transmit print data to the communication unit 807 of the MFP 1 through Internet 32 and the LAN cable 33.

Next, a method of setting printing setting information and inhibition information will be described. The external PC 31 transmits print data including printing setting information serving as first information and inhibition information serving as second information to the MFP 1 or the internal PC 21. The inhibition information is information, which is inhibited from being changed through the operation display unit 805, among the printing setting information. Print data may be set in the external PC 31. Print data may include ID information which restricts a person who logs in the MFP 1 to a specific person.

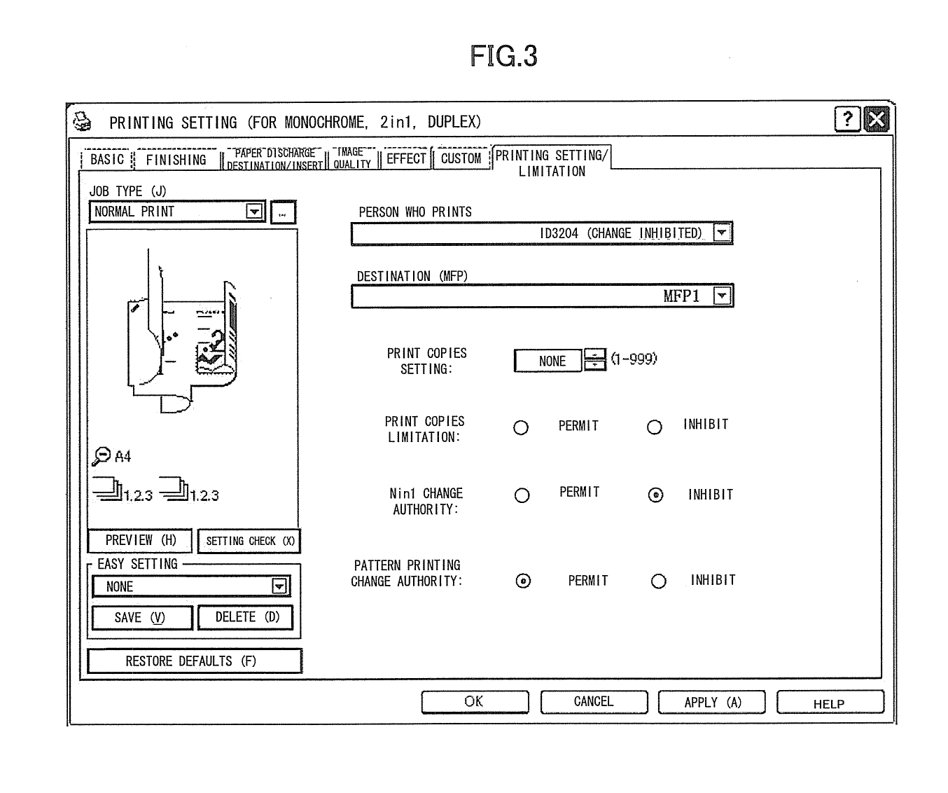

FIG. 3 shows a display screen of the external PC 31. The display screen schematically shows a setting screen on which the printing setting information and the inhibition information are set. Referring to FIG. 3, the printing setting information includes “the model number of an MFP which performs printing” and “Nin1”. The MFP which performs printing is designated as “MFP1”, and “Nin1” is designated as “2in1”. “Nin1” represents the number of sheets of the original document to be printed per page. For example, “2in1” refers to a printing mode in which two sheets of the original document are printed per page. The inhibition information is “Nin1 cannot be changed”.

Therefore, the controller 801 inhibits the printing mode from being changed from “2in1” to another mode. Print data is printed in the mode “2in1” as intended by a creator who creates print data.

With regard to “pattern printing”, no printing setting is made. The setting of “pattern printing” is made on a screen different from the display screen shown in FIG. 3.

In order to inhibit the setting of “pattern printing” from being changed, “pattern printing change authority” displayed on the display screen shown in FIG. 3 is changed to “inhibit”.

The MFP which performs printing is set as the MFP 1. Thus, if “OK”, which is displayed on the display screen, is clicked, the external PC 31 transmits print data to the communication unit 807 of the MFP 1. The model number of the MFP which performs printing is not included in the printing setting information inhibited from being changed. Therefore, another MFP other than MFP 1 may perform printing on the basis of print data.

In setting the number of print copies, “none” displayed laterally to “print copies setting” on the display screen is erased, and a specific number of sheets is input. In inhibiting the designated number of copies from being changed, “print copies limitation” is set as “inhibit”. In the MFP 1, when there is a login based on an ID number other than “ID3204”, the controller 801 inhibits access to print data.

The printing setting information may include information regarding stapling and information regarding duplex printing. The inhibition information may include information regarding a limitation of changes to set stapling, and information regarding a limitation of changes to set duplex printing.

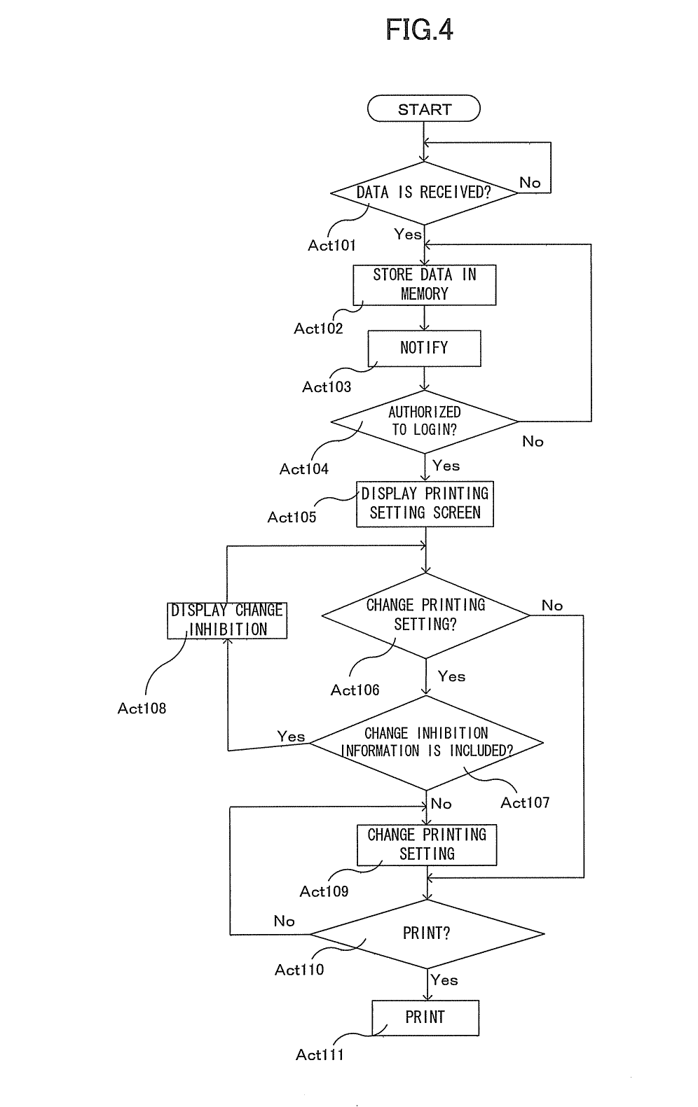

Next, a printing method of the MFP 1 will be described with reference to a flowchart of FIG. 4. Referring to this flowchart, print data is transmitted directly from the external PC 31 to the MFP 1. In Act 101, the controller 801 determines whether or not the communication unit 807 receives print data including printing setting information and inhibition information.

In Act 102, the controller 801 stores received print data in the memory 803, and progresses to Act 103. In Act 103, the controller 801 displays, on the operation display unit 805, reception information indicating that print data is received.

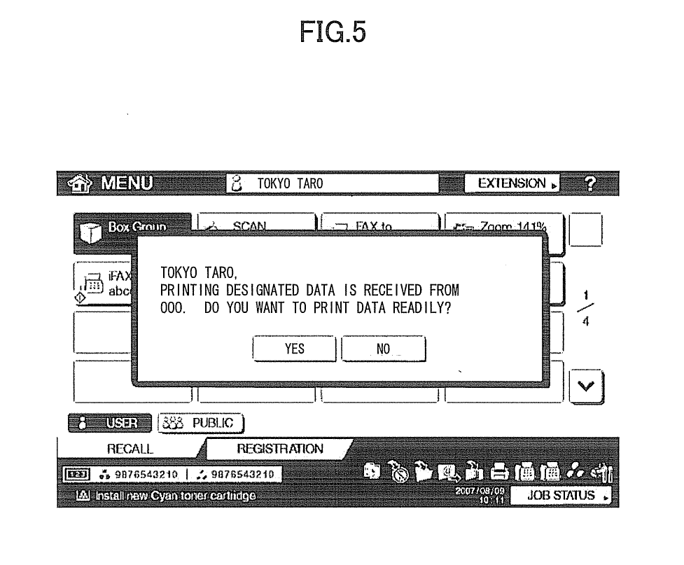

FIG. 5 is a schematic view schematically showing reception information displayed on the operation display unit 805. Referring to the schematic view, the name (Tokyo Taro) of an access-authorized person corresponding to ID3204 and the name (OOO) of a transmitter are displayed on the operation display unit 805.

In Act 104, the controller 801 determines whether or not a person who is authorized to login logs in the MFP 1. In Act 104, when it is determined that a person who is authorized to login logs in the MFP 1, the controller 801 progresses to Act 105. In Act 105, the controller 801 displays a printing setting screen on the operation display unit 805, and progresses to Act 106.

In Act 106, the controller 801 determines whether or not an operation is made to change a printing setting. In Act 106, when it is determined that an operation is not made to change a printing setting, the controller 801 progresses to Act 110.

In Act 106, when it is determined that an operation is made to change a printing setting, the controller 801 progresses to Act 107. In Act 107, the controller 801 determines whether or not the printing setting which undergoes the change operation corresponds to the inhibition information. In Act 107, when it is determined that the printing setting which undergoes the change operation corresponds to the inhibition information, the controller 801 progresses to Act 108. In Act 108, the controller 801 displays, on the operation display unit 805, an indication that the printing setting is inhibited from being changed.

In Act 107, when it is determined that the printing setting which undergoes the change operation does not correspond to the inhibition information, the controller 801 progresses to Act 109. In Act 109, the controller 801 changes the printing setting, and progresses to Act 110.

In Act 110, the controller 801 determines whether or not a printing operation is instructed through the operation display unit 805, and when the printing operation is instructed, progresses to Act 111. In Act 111, the controller 801 instructs the start of the printing operation.

### Second Embodiment

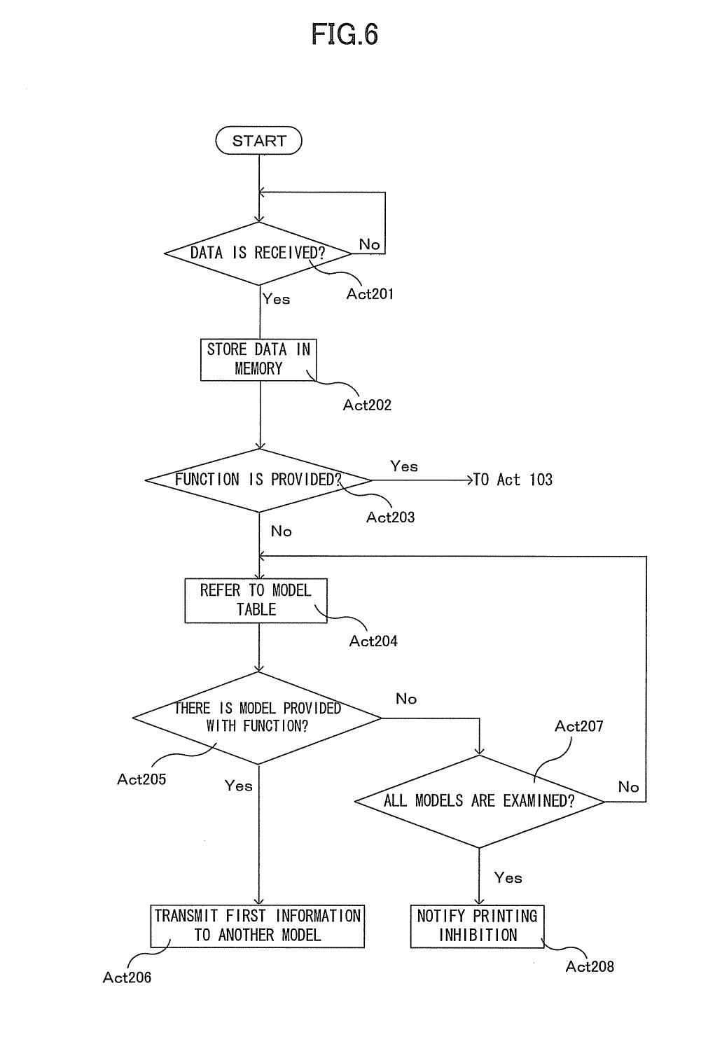

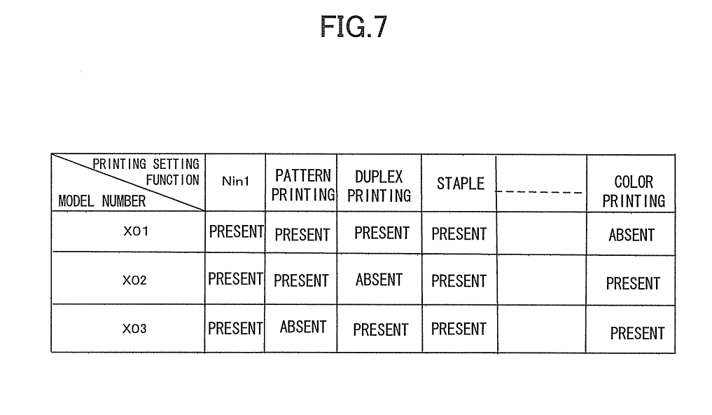

A processing method when the MFP 1 does not have a function corresponding to the printing setting information set in advance will be described with reference to FIGS. 6 and 7. FIG. 6 is a flowchart of the processing method. FIG. 7 is a data table (third information) which represents the printing functions of other MFPs which are communicable with the MFP 1. Other MFPs are represented by model numbers. An MFP with a model number X01 does not have a color printing function, but has all other printing functions. An MFP with a model number X02 does not have a duplex printing function, but has all other printing functions. An MFP with a model number X03 does not have a pattern printing function, but has all other printing functions.

Referring to FIG. 6, in Act 201, the controller 801 determines whether or not the communication unit 807 receives print data, and when print data is received, progresses to Act 202. In Act 202, the controller 801 stores print data received by the communication unit 807 in the memory 803, and progresses to Act 203.

In Act 203, the controller 801 determines whether or not the MFP 1 is provided with all functions corresponding to the printing setting information. In Act 203, when it is determined that the MFP 1 is provided with all functions corresponding to the printing setting information, the controller 801 progresses to Act 103 in the flowchart of FIG. 4 according to the first embodiment.

In Act 203, when it is determined that the MFP 1 is not provided with at least one of the printing functions corresponding to the printing setting information, the controller 801 progresses to Act 204.

In Act 204, the controller 801 reads information regarding the printing functions of the model number X01 with reference to a database of FIG. 7, and progresses to Act 205. In Act 205, the controller 801 determines whether or not the MFP with the model number X01 is provided with all printing functions corresponding to the printing setting information. When the MFP with the model number X01 is provided with all printing functions corresponding to the printing setting information, the controller 801 progresses to Act 206. In Act 206, the controller 801 outputs a signal (first signal) to the communication unit 807, such that the communication unit 807 transmits print data to the MFP with the model number X01.

In Act 205, when it is determined that the MFP with the model number X01 is not provided with at least one of the printing functions corresponding to the printing setting information, the controller 801 progresses to Act 207. In Act 207, the controller 801 determines whether or not the processing of Act 205 is performed for all other MFPs.

In Act 207, when it is determined that the processing of Act 205 is not performed for all other MFPs, the controller 801 returns to Act 204. In Act 204, the controller 801 reads information regarding the printing functions of the model number X02 accumulated in the database of FIG. 7, and progresses to Act 205.

In Act 207, when it is determined that all models of MFPs are examined, the controller 801 progresses to Act 208, and notifies the operation display unit 805 of printing inhibition.

In the second embodiment, when it is determined that the MFP 1 is not provided with at least one of the printing functions corresponding to the printing setting information, the controller 801 may output the signal (first signal) immediately and may display printing inhibition on the operation display unit 805.

### Third Embodiment

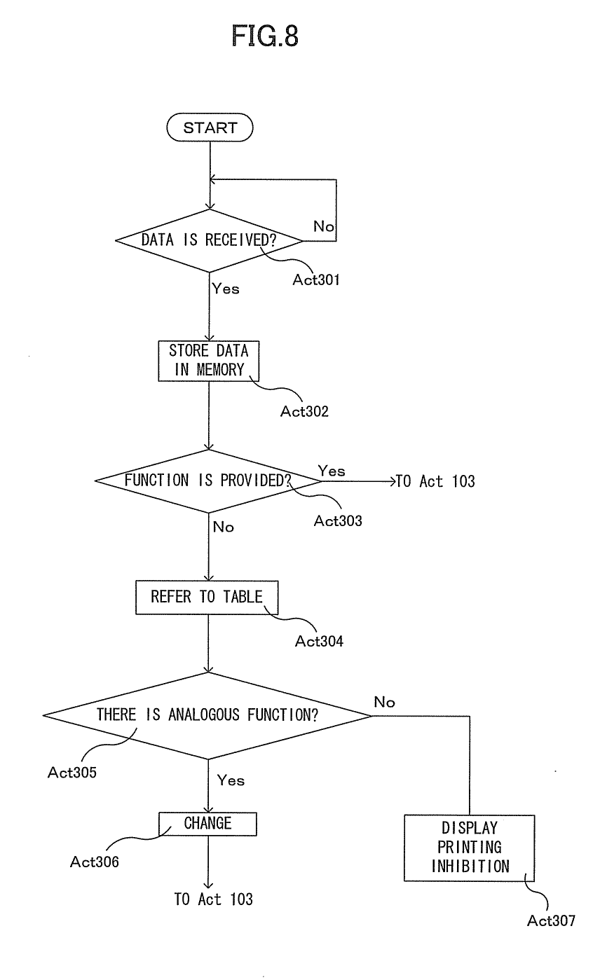

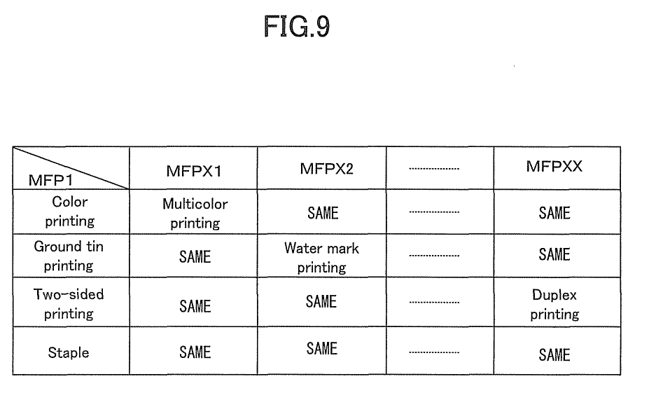

A third embodiment will be described with reference to FIGS. 8 and 9. FIG. 8 is a flowchart showing a printing method of this embodiment. FIG. 9 is a data table (fourth information) which represents the analogous relationship between the printing functions of the MFP 1 and the printing functions of another MFP of a model different from the MFP 1.

The printing setting functions may have different names in accordance with the models of the MFPs even when the contents of the functions are identical. For example, with regard to the function for recording images on both sides of a recording sheet, while an MFP of a model A may call the function “Two-sided printing”, an MFP of a model B may call the function “Duplex printing”. Therefore, although printing setting information “Duplex printing” is included in print data such that images are to be recorded on both sides of the recording sheet, since printing setting information “Two-sided printing” is not included in print data, the controller 801 erroneously determines that there is no function for recording images on both sides of the recording sheet.

In Act 301, the controller 801 determines whether or not the communication unit 807 receives print data. In Act 302, the controller 801 stores received print data in the memory 803, and progresses to Act 303. In Act 303, the controller 801 determines whether or not the MFP 1 is provided with printing functions corresponding to the printing setting information.

In Act 303, when it is determined that the MFP 1 is provided with all printing functions corresponding to the printing setting information, the controller 801 progresses to Act 103 of the first embodiment. In Act 303, when it is determined that the MFP 1 is not provided with at least one of the printing functions corresponding to the printing setting information, the controller 801 progresses to Act 304.

In Act 304, the controller 801 references the data table, and progresses to Act 305. In Act 305, the controller 801 determines whether or not the MFP 1 is provided with a printing function analogous to the printing function which is determined to be lacking.

Referring to the data table of FIG. 9, for example, it is assumed that the names of the respective printing settings of the MFP 1 are “Color printing”, “Ground tin printing”, “Two-sided printing”, and “Staple”. When the names of the respective printing settings of print data created by an MFP X2 are “Color printing”, “Watermark printing”, “Two-sided printing”, and “Staple”, the controller 801 determines that the MFP 1 has a printing function analogous to “Watermark printing” since the MFP 1 has a printing function called “Ground tin printing” as a pattern printing.

In Act 306, the controller 801 changes the printing setting information so as to be fit to the printing function of the MFP 1, and progresses to Act 103 of the first embodiment. In Act 305, when it is determined that there is no analogous printing function, the controller 801 progresses to Act 307. In Act 307, the controller 801 displays printing inhibition on the operation display unit 805.

At least a part of various kinds of processing which are realized through execution of a program by a processor in the above-described embodiments may be carried out by an ASIC 802 using a circuit.

As described above, according to the technique described in this specification, printed matter is obtained as intended by the creator who creates print data.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the sprit of the inventions. The accompanying claims and their equivalents are intended to cover such forms or modifications as would fall within the scope and spirit of the inventions.

What is claimed is:

1. A printing apparatus comprising:
a communication unit configured to receive print data including first information regarding printing setting information set in advance and second information regarding inhibition information with printing settings inhibited from being changed among the first information;
an operation unit configured to be operated so as to change the printing setting information of print data; and
a controller configured to inhibit the printing setting information corresponding to the second information from being changed through the operation unit.

2. The apparatus according to claim 1,
wherein the printing setting information corresponding to the second information is information indicating the number of sheets of an original document to be printed per page.

3. The apparatus according to claim 1,
wherein the printing setting information corresponding to the second information is information indicating pattern printing.

4. The apparatus according to claim 1, further comprising:
a memory which stores print data.

5. The apparatus according to claim 4,
wherein, when the printing apparatus is not provided with at least one of the printing functions corresponding to the printing setting information included in print data, the controller outputs a first signal indicating that there is no printing function.

6. The apparatus according to claim 5,
wherein the communication unit transmits print data to another printing apparatus different from the printing apparatus on the basis of the first signal.

7. The apparatus according to claim 6,
wherein the printing apparatus communicates with a plurality of external printing apparatuses, and
the controller selects, as another printing apparatus, an external printing apparatus, which includes all the printing functions corresponding to the printing setting information included in print data, from among a plurality of external printing apparatuses.

8. The apparatus according to claim 7,
wherein the memory includes third information regarding the printing functions of each external printing apparatus.

9. The apparatus according to claim 4,
wherein the memory includes fourth information indicating that a first printing function of the printing apparatus is the same as a second printing function of another printing apparatus, the model of which is different from the printing apparatus, and
when print data includes the printing setting information corresponding to the second printing function, the controller performs printing on the basis of the first printing function, instead of the second printing function.

10. The apparatus according to claim 1,
wherein print data includes ID information which is input through the operation unit at the time of login to the printing apparatus, and
the controller permits printing of data to be printed included in print data only if there is an input based on the ID information.

11. A printing control method for a printing apparatus, the method comprising:
receiving print data including first information regarding printing setting information set in advance and second information regarding inhibition information with printing settings inhibited from being changed among the first information; and
when printing is performed, inhibiting the printing setting information corresponding to the second information from being changed through an operation unit of the printing apparatus.

12. The method according to claim 11,
wherein the printing setting information corresponding to the second information is information indicating the number of sheets of an original document to be printed per page.

13. The method according to claim 11,
wherein the printing setting information corresponding to the second information is information indicating pattern printing.

14. The method according to claim 11,
wherein print data is stored in a memory.

15. The method according to claim 14,
wherein, when the printing apparatus is not provided with at least one of the printing functions corresponding to the printing setting information included in print data, it is determined that there is no printing function.

16. The method according to claim 15,
wherein, when there is no printing function, print data is transmitted to another printing apparatus.

17. The method according to claim 16,
wherein an external printing apparatus, which includes all the printing functions corresponding to the printing setting information included in print data, from among a plurality of external printing apparatuses is selected as another printing apparatus.

18. The method according to claim 17,
wherein the memory includes third information regarding the printing functions of each external printing apparatus.

19. The method according to claim 14,
wherein the memory includes fourth information indicating that a first printing function of the printing apparatus is the same as a second printing function of another printing apparatus, the model of which is different from the printing apparatus, and
when print data includes the printing setting information corresponding to the second printing function, printing is performed on the basis of the first printing function, instead of the second printing function.

20. The method according to claim 11,
wherein, when print data includes ID information, printing of data to be printed included in print data is permitted only if a login based on the ID information is made through the operation unit of the printing apparatus.
